(19) United States
(12) Patent Application Publication
(10) Pub. No.: US 2021/0008477 A1
(43) Pub. Date: Jan. 14, 2021

(54) LONG-FIBER NONWOVEN FABRIC AND FILTER REINFORCEMENT MATERIAL USING THE SAME

(71) Applicant: TOYOBO CO., LTD., Osaka-shi, Osaka (JP)

(72) Inventors: Hideo Yoshida, Otsu-shi, Shiga (JP); Chiaki Katsuki, Otsu-shi, Shiga (JP); Masahiro Saijo, Otsu-shi, Shiga (JP)

(73) Assignee: TOYOBO CO., LTD., Osaka-shi, Osaka (JP)

(21) Appl. No.: 16/982,712

(22) PCT Filed: Mar. 18, 2019
(86) PCT No.: PCT/JP2019/011081

§ 371 Date: Sep. 21, 2020

(30) Foreign Application Priority Data
Mar. 23, 2018 (JP) 2018-056331

(51) Int. Cl. B01D 39/16; D01F 8/14; D04H 3/011

(52) U.S. Cl. CPC B01D 39/1623; D01F 8/14; D04H 3/011; B01D 2239/1233; B01D 2239/0618; B01D 2239/0208; D10B 2505/04

(57) ABSTRACT

A long-fiber nonwoven fabric includes fibers having a birefringence (Δn) of more than or equal to 0.005 and less than or equal to 0.020, a degree of crystallization of less than or equal to 25%, and an average fiber diameter of more than or equal to 30 μm and less than or equal to 60 μm, and has a basis weight amount of more than or equal to 50 g/m² and less than or equal to 120 g/m², and a folding angle after being pressed for 10 seconds under a pressure of 5.2 kPa at 80° C. of less than or equal to 15°. Thus, the long-fiber nonwoven fabric has pleating property suitable for a filter reinforcement material, and also has rigidity that satisfies pleat shape retention property.

### TECHNICAL FIELD

The present invention relates to a long-fiber nonwoven fabric suitable for a filter reinforcement material, and a filter reinforcement material using the same.

### BACKGROUND ART

Polyethylene terephthalate long-fiber nonwoven fabrics have good dynamic physical properties, also have air permeability and water permeability, and are used for many applications. However, when a polyethylene terephthalate long-fiber nonwoven fabric is used as a material for a molded body, it is difficult for the fabric to follow a mold such as an uneven mold in a wide temperature range, and to be molded in various shapes.

In an air purifier or a cabin filter for a car, it is common to use a pleated filter in order to improve dust removal performance, smoke removal performance, and the like. When a nonwoven fabric is used as a reinforcement material for the filter, the nonwoven fabric to be used is required to have a property that it can be pleated to have an arbitrary number of pleats and an arbitrary spacing therebetween. In addition, the filter is required to have rigidity having pleat shape retention property that avoids occurrence of contact or close contact between pleats when the filter is actually used as a filter unit including stacked adsorbents such as activated carbon, and the nonwoven fabric serving as a reinforcement material is also required to have rigidity.

As nonwoven fabrics used as a filter reinforcement material, a short-fiber nonwoven fabric using polyethylene terephthalate-based core-sheath composite fibers having a low melting-point resin arranged in a sheath component, and a long-fiber nonwoven fabric having low melting-point resin fibers mixed therein are proposed (see, for example, PTLs 1 to 2). Although these nonwoven fabrics have both pleating property and pleat shape retention property, manufacturing-related costs thereof are high.

On the other hand, a filter reinforcement material using a polyethylene terephthalate long-fiber nonwoven fabric that improves pleat shape retention property and durability of a filter is proposed (see, for example, PTL 3). However, since the basis weight amount is increased to improve rigidity and secure shape retention property in this filter reinforcement material, a filter unit has an increased pressure loss and a poor pleating property due to an increase in thickness.

### CITATION LIST

### Patent Literature

PTL 1: Japanese Patent Laying-Open No. 2008-231597

PTL 2: Japanese Patent Laying-Open No. 2000-199164

PTL 3: Japanese Patent Laying-Open No. 2011-000536

### SUMMARY OF INVENTION

### Technical Problem

The present invention has been made in view of the aforementioned circumstances, and a problem to be solved thereby is to obtain a long-fiber nonwoven fabric having pleating property suitable for a filter reinforcement material, and also having rigidity that satisfies pleat shape retention property.

### Solution to Problem

As a result of earnest studies, the present inventors have found that the aforementioned problem can be solved by means described below, and have arrived at the present invention. Specifically, the present invention is as follows.
1. A long-fiber nonwoven fabric comprising fibers having a birefringence (Δn) of more than or equal to 0.005 and less than or equal to 0.020, a degree of crystallization of less than or equal to 25%, and an average fiber diameter of more than or equal to 30 μm and less than or equal to 60 μm, the long-fiber nonwoven fabric having a basis weight amount of more than or equal to 50 g/m² and less than or equal to 120 g/m², and a folding angle after being pressed for 10 seconds under a pressure of 5.2 kPa at 80° C. of less than or equal to 15°.
2. The long-fiber nonwoven fabric according to 1 described above, wherein an average value of aspect ratios of fiber cross sections of the fibers constituting the long-fiber nonwoven fabric is more than or equal to 1.05 and less than or equal to 1.2.
3. The long-fiber nonwoven fabric according to 1 or 2 described above, wherein the fibers constituting the long-fiber nonwoven fabric are single fibers made of a resin containing polyethylene terephthalate serving as a main component and more than or equal to 0.02 mass % and less than or equal to 5 mass % of a thermoplastic polystyrene-based copolymer mixed thereto.
4. The long-fiber nonwoven fabric according to 4 described above, wherein the thermoplastic polystyrene-based copolymer has a glass transition point temperature of more than or equal to 100° C. and less than or equal to 160° C.

5. A filter reinforcement material using the long-fiber nonwoven fabric according to any one of 1 to 4 described above.

### Advantageous Effects of Invention

According to the present invention, with the above configuration, a long-fiber nonwoven fabric suitable for a filter reinforcement material is obtained, which is excellent in pleating property, has rigidity that is less likely to cause close contact between pleats under actual use, and is excellent in pleat shape retention property. In addition, since the long-fiber nonwoven fabric is made of fibers having a single component, a long-fiber nonwoven fabric that is manufactured at an inexpensive cost can be provided.

### DESCRIPTION OF EMBODIMENTS

In order to obtain a long-fiber nonwoven fabric which is excellent in pleating property, is excellent in pleat shape retention property, and has rigidity suitable for a filter reinforcement material, the present inventors conducted earnest studies. As a result, the present inventors have found that a long-fiber nonwoven fabric suitable for a filter reinforcement material can be obtained by utilizing a long-fiber nonwoven fabric including fibers mainly made of polyethylene terephthalate having a degree of crystallization of less than or equal to 25%.

Hereinafter, a long-fiber nonwoven fabric of the present invention will be described in detail.

Fibers constituting the long-fiber nonwoven fabric of the present invention have a birefringence index (Δn) of more than or equal to 0.005 and less than or equal to 0.020, preferably more than or equal to 0.007 and less than or equal to 0.015, and more preferably more than or equal to 0.008 and less than or equal to 0.012. When the birefringence index (Δn) is less than 0.005, the long-fiber nonwoven fabric has an excellent pleating property, but has a decreased rigidity due to deformation of the fibers. Thus, contact or close contact between pleats is likely to occur when the long-fiber nonwoven fabric is actually used as a filter reinforcement material. When the birefringence index (Δn) is more than 0.020, the long-fiber nonwoven fabric has an improved rigidity and can serve as a filter reinforcement material excellent in shape retention property, but it is difficult to pleat the long-fiber nonwoven fabric to have an arbitrary number of pleats and an arbitrary spacing therebetween.

The fibers constituting the long-fiber nonwoven fabric of the present invention have a degree of crystallization of less than or equal to 25%, preferably more than or equal to 5% and less than or equal to 20%, and more preferably more than or equal to 10% and less than or equal to 15%. When the degree of crystallization is more than 25%, the long-fiber nonwoven fabric has an improved rigidity and can serve as a filter reinforcement material excellent in shape retention property, but it is difficult to pleat the long-fiber nonwoven fabric to have an arbitrary number of pleats and an arbitrary spacing therebetween. Although the lower limit of the degree of crystallization is not particularly limited, when the degree of crystallization is less than 5%, the long-fiber nonwoven fabric has a decreased rigidity, and thus contact or close contact between pleats is likely to occur when the long-fiber nonwoven fabric is actually used as a filter reinforcement material.

The fibers constituting the long-fiber nonwoven fabric of the present invention have an average fiber diameter of more than or equal to 30 μm and less than or equal to 60 μm, and the long-fiber nonwoven fabric has a basis weight amount of more than or equal to 50 g/m² and less than or equal to 120 g/m². Although the combination of the average fiber diameter of the fibers constituting the long-fiber nonwoven fabric and the basis weight amount of the long-fiber nonwoven fabric is not particularly limited, it is preferable to increase the average fiber diameter when decreasing the basis weight amount, and to decrease the average fiber diameter when increasing the basis weight amount. Specifically, when the basis weight amount is more than or equal to 50 g/m² and less than or equal to 70 g/m², the average fiber diameter is preferably more than or equal to 50 μm and less than or equal to 60 μm; when the basis weight amount is more than or equal to 70 g/m² and less than or equal to 90 g/m², the average fiber diameter is preferably more than or equal to 40 μm and less than or equal to 50 μm; and when the basis weight amount is more than or equal to 90 g/m² and less than or equal to 120 g/m², the average fiber diameter is preferably more than or equal to 30 μm and less than or equal to 40 μm.

The long-fiber nonwoven fabric of the present invention has a folding angle after being pressed for 10 seconds under a pressure of 5.2 kPa at 80° C. of less than or equal to 15°, preferably less than or equal to 10°, and more preferably less than or equal to 5°. When the folding angle is more than 15°, the long-fiber nonwoven fabric has an improved rigidity and can serve as a filter reinforcement material excellent in shape retention property, but it is difficult to pleat the long-fiber nonwoven fabric to have an arbitrary number of pleats and an arbitrary spacing therebetween. Although the lower limit of the folding angle after being pressed for 10 seconds under a pressure of 5.2 kPa at 80° C. is not particularly limited, it is usually more than or equal to 5°.

An average value of aspect ratios of fiber cross sections of the fibers constituting the long-fiber nonwoven fabric of the present invention is preferably more than or equal to 1.05 and less than or equal to 1.2. When the average value of the aspect ratios is less than 1.05, the long-fiber nonwoven fabric has an improved rigidity and can serve as a filter reinforcement material excellent in shape retention property, but it is difficult to pleat the long-fiber nonwoven fabric to have an arbitrary number of pleats and an arbitrary spacing therebetween. When the average value of the aspect ratios is more than 1.2, the long-fiber nonwoven fabric has an excellent pleating property, but has a decreased rigidity due to deformation of the fibers. Thus, contact or close contact between pleats is likely to occur when the long-fiber nonwoven fabric is actually used as a filter reinforcement material.

The fibers constituting the long-fiber nonwoven fabric of the present invention are preferably single fibers made of a resin containing polyethylene terephthalate serving as a main component and a thermoplastic polystyrene-based copolymer mixed thereto. Polyethylene terephthalate is more excellent in mechanical strength, heat resistance, shape retention property, and the like, than resins such as polyethylene and polypropylene. In order to effectively exhibit such effects, the content of the polyethylene terephthalate serving as a main component in the resin used for the fibers constituting the long-fiber nonwoven fabric of the present invention is preferably more than or equal to 90 mass % and less than or equal to 99.8 mass %, more preferably more than or equal to 93 mass % and less than or equal to 99.5 mass %, and further preferably more than or equal to 94 mass % and less than or equal to 98 mass %, with respect to 100 mass % of the entire long-fiber nonwoven fabric, when the mixed amount of the thermoplastic polystyrene-based copolymer is taken into consideration. It should be noted that, other than polyethylene terephthalate, a polyester resin such as polytrimethylene terephthalate, polybutylene terephthalate, or polyethylene naphthalate may be blended, as long as the content thereof is less than or equal to 10 mass %.

It should be noted that, in the present invention, the “single fibers” mean that they are not composite cross-section fibers such as core-sheath type composite cross-section fibers, side-by-side type composite cross-section fibers, or the like, and does not exclude a mixed resin composition as a resin used for fibers. That is, fibers which are not in the form of composite cross-section fibers and use a mixed resin composition are included in the “single fibers” in the present invention.

The polyethylene terephthalate used for the present invention has an intrinsic viscosity of preferably more than or equal to 0.3 dl/g, more preferably more than or equal to 0.4 dl/g, further preferably more than or equal to 0.5 dl/g, and most preferably more than or equal to 0.55 dl/g. By setting the intrinsic viscosity of the polyethylene terephthalate to more than or equal to 0.3 dl/g, the resin is less likely to be thermally deteriorated, and the long-fiber nonwoven fabric can have an improved durability.

The thermoplastic polystyrene-based copolymer used for the present invention has a glass transition point temperature of preferably more than or equal to 100° C. and less than or equal to 160° C., more preferably more than or equal to 110° C. and less than or equal to 155° C., and further preferably more than or equal to 120° C. and less than or equal to 150° C. In addition, the thermoplastic polystyrene-based copolymer is preferably incompatible in the polyethylene terephthalate. When the thermoplastic polystyrene-based copolymer has a glass transition point temperature which is higher than that of the polyethylene terephthalate and is more than or equal to 100° C., crystallization of the fibers constituting the long-fiber nonwoven fabric can be suppressed. As the effect thereof, for example, by applying heat under planar constraint described later, the fibers can be stuck to each other and can further be processed into a long-fiber nonwoven fabric having less dimensional change due to suppressed thermal shrinkage. On the other hand, the glass transition point temperature is preferably less than or equal to 160° C., when spinning productivity is taken into consideration. The glass transition point temperature is a value obtained by being measured at a temperature increasing rate of 20° C./minute according to JIS K7122 (1987).

Although the thermoplastic polystyrene-based copolymer used for the present invention is not particularly limited as long as it has a glass transition point temperature of more than or equal to 100° C. and less than or equal to 160° C., it is preferably a styrene-conjugated diene block copolymer, an acrylonitrile-styrene copolymer, an acrylonitrile-butadiene-styrene copolymer, a styrene-acrylic acid ester copolymer, or a styrene-methacrylic acid ester copolymer, for example. Among these copolymers, a styrene-acrylic acid ester copolymer or a styrene-methacrylic acid ester copolymer is more preferable, and a styrene-methacrylic acid ester copolymer is further preferable. Examples of the styrene-methacrylic acid ester copolymer include a styrene-methyl methacrylate-maleic anhydride copolymer. These copolymers may be contained alone or in combination. Examples of commercially available products include PLEXIGLAS HW55 manufactured by Rohm GmbH & Co. KG, which is particularly preferable because it exhibits an excellent effect with a small additive amount.

The mixed amount of the thermoplastic polystyrene-based copolymer is preferably more than or equal to 0.02 mass % and less than or equal to 5 mass %, more preferably more than or equal to 0.05 mass % and less than or equal to 4 mass %, and further preferably more than or equal to 0.1 mass % and less than or equal to 3 mass %, with respect to 100 mass % of the entire long-fiber nonwoven fabric. The effect of addition described above is obtained by setting the mixed amount to more than or equal to 0.02 mass %. Although the upper limit of the mixed amount of the thermoplastic polystyrene-based copolymer is not particularly limited, if it is excessively mixed, the fibers are broken due to a difference in stretchability between the polyethylene terephthalate and the thermoplastic polystyrene-based copolymer, causing a deterioration in operability. Thus, the mixed amount of the thermoplastic polystyrene-based copolymer is preferably less than or equal to 5 mass %.

The long-fiber nonwoven fabric of the present invention is preferably a planar constraint long-fiber nonwoven fabric, especially a planar constraint spunbond nonwoven fabric. Planar constraint used herein is to planarly sandwich a fiber web in a thickness direction and planarly apply pressure thereon. Planar constraint can be performed, for example, by pressing the entire sheet of the fiber web between a flat roll and a sheet-like body such as a felt belt, a rubber belt, or a steel belt. In addition, although the fiber web subjected to temporary compression bonding is subjected to permanent compression bonding (thermosetting) under planar constraint in the present invention, this is different from partial compression bonding that performs compression bonding between a flat roll and an engraved roll or between engraved rolls, and linear compression bonding that performs compression bonding between flat rolls. In the case of partial compression bonding, fibers are partially fixed, and thus a stress concentrates on a compression-bonded portion and a long-fiber nonwoven fabric difficult to be pleated is obtained. Further, in the case of linear compression bonding, fibers are entirely compression-bonded excessively, and thus the fibers are deformed and a long-fiber nonwoven fabric having a low bending resistance and a high pressure loss is obtained. On the other hand, when compression bonding is performed under planar constraint, thermal shrinkage of the fiber web in an in-plane direction can be suppressed. As a result, in the obtained planar constraint long-fiber nonwoven fabric, the fibers are fixed to each other over the entire sheet while being suppressed from deformation. Thus, the planar constraint long-fiber nonwoven fabric has an excellent bending resistance.

The long-fiber nonwoven fabric of the present invention is preferably a long-fiber nonwoven fabric not subjected to mechanical interlacing. In the case of a long-fiber nonwoven fabric subjected to mechanical interlacing, it is difficult to sharply pleat the long-fiber nonwoven fabric, which is not preferable. Further, in the case of a nonwoven fabric made of short fibers, local deformation due to slip of the fibers or the like occurs, and it is difficult to pleat the nonwoven fabric to have an equal spacing between pleats.

Next, a method for manufacturing the long-fiber nonwoven fabric of the present invention will be described.

The method for manufacturing the long-fiber nonwoven fabric of the present invention includes the step of performing spinning at a ratio between a take-up velocity and a discharge linear velocity (hereinafter referred to as a “draft ratio”) of less than or equal to 200, and the step of performing temporary compression bonding on a fiber web obtained after spinning and then performing permanent compression bonding thereon under planar constraint.

First, according to a conventional method, predetermined amounts of polyethylene terephthalate and a thermoplastic polystyrene-based copolymer are blended and dried, and thereafter spinning is performed using a melt spinning machine.

In the present invention, it is preferable to set the draft ratio to less than or equal to 200 to obtain a long-fiber nonwoven fabric having a suitable birefringence index (Δn). When the draft ratio is more than 200, the degree of crystallization of the fibers constituting the long-fiber nonwoven fabric becomes high, and a long-fiber nonwoven fabric difficult to be pleated is obtained. The draft ratio is more preferably less than or equal to 175, and is further preferably less than or equal to 150.

The draft ratio is provided by the following equations:

draft ratio (ψ)=take-up velocity (Vs)/discharge linear velocity (V₀) (Ratio between Take-up Velocity and Discharge Linear Velocity)

discharge linear velocity (V₀)=single hole discharge amount (Q)/spinneret hole cross-sectional area (Da). (Discharge Linear Velocity)

Although other spinning conditions are not particularly limited, it is preferable to spin a yarn from a spinneret, supply dry air to an ejector at a pressure (jet pressure) of more than or equal to 0.3 kg/cm² and less than or equal to 2.0 kg/cm², and draw the yarn. Further, by controlling the pressure of supplying the dry air within the above range, the take-up velocity can be easily controlled to be within a desired range, and the yarn can be appropriately dried.

Then, the discharged yarn is cooled, and fibers of the yarn are opened onto a conveyor located below and are collected. Thereby, a fiber web (long-fiber fleece) may be obtained.

According to a common method for manufacturing a spunbond nonwoven fabric, the obtained fiber web is subjected to embossing or the like that performs partial compression bonding between a flat roll and an engraved roll or between engraved rolls. However, since the fiber web obtained by spinning at a low spinning speed as in the present invention has a low orientation and is likely to shrink, problems such as width shrinkage and wrinkling occur when the fiber web is subjected to embossing or the like. In the present invention, temporary compression bonding is performed and then permanent compression bonding is performed under planar constraint as described below, which can easily suppress occurrence of width shrinkage and wrinkling.

Temporary compression bonding is to compression-bond a fiber web by applying pressure thereon in the thickness direction. Temporary compression bonding is performed to cause planar constraint in permanent compression bonding to be easily performed. For example, thermocompression bonding may be performed using a pair of temporary thermocompression bonding rolls including two flat rolls, at a surface temperature of each flat roll of more than or equal to 60° C. and less than or equal to 140° C., and a pushing pressure of more than or equal to 5 kN/m and less than or equal to 30 kN/m. The surface temperature of each flat roll is more preferably more than or equal to 70° C. and less than or equal to 120° C., and the pushing pressure is more preferably more than or equal to 7 kN/m and less than or equal to 20 kN/m.

Further, for easier permanent compression bonding, the fiber web subjected to temporary compression bonding may be subjected to hydrous treatment by which water is sprayed on the fiber web with a spray such that the fiber web has a water content of more than or equal to 1 mass % and less than or equal to 30 mass %.

Then, permanent compression bonding is performed. Permanent compression bonding is to thermoset and compression-bond the fiber web subjected to temporary compression bonding, under planar constraint. Planar constraint is preferably performed using a flat roll and a sheet-like body such as a felt belt, a rubber belt, or a steel belt, as described above. Among these belts, a felt belt is particularly preferable, because its surface is fibrous and it easily constrains the fiber web in the in-plane direction. Further, when permanent compression bonding is performed under planar constraint, the fibers are fixed over the entire sheet. Thereby, deformation of the fibers are suppressed, and an excellent bending resistance can be obtained.

Thermosetting and planar constraint are preferably performed at a surface temperature of the roll of more than or equal to 120° C. and less than or equal to 180° C., under conditions of a pushing pressure of more than or equal to 10 kPa and less than or equal to 400 kPa, a processing time of more than or equal to 3 seconds and less than or equal to 30 seconds, and a processing speed of more than or equal to 1 m/minute and less than or equal to 30 m/minute.

The surface temperature of the roll is preferably set to more than or equal to 120° C., because compression bonding is easily performed. The surface temperature of the roll is more preferably set to more than or equal to 130° C. On the other hand, the surface temperature of the roll is preferably set to less than or equal to 180° C., because excessive compression bonding is suppressed. The surface temperature of the roll is more preferably set to less than or equal to 160° C.

The pushing pressure is preferably set to more than or equal to 10 kPa, because planar constraint is easily performed. The pushing pressure is more preferably set to more than or equal to 30 kPa, further preferably set to more than or equal to 50 kPa, particularly preferably set to more than or equal to 100 kPa, and most preferably set to more than or equal to 200 kPa. On the other hand, the pushing pressure is preferably set to less than or equal to 400 kPa, because excessive compression bonding is suppressed. The pushing pressure is more preferably set to less than or equal to 350 kPa, and further preferably set to less than or equal to 300 kPa.

The processing time is preferably set to more than or equal to 3 seconds, because compression bonding is easily performed. The processing time is more preferably set to more than or equal to 5 seconds. On the other hand, the processing time is preferably set to less than or equal to 35 seconds, because excessive compression bonding is suppressed. The processing time is more preferably set to less than or equal to 20 seconds, and further preferably set to less than or equal to 15 seconds.

By setting the processing speed to preferably more than or equal to 1 m/minute, excessive compression bonding is suppressed. The processing speed is more preferably more than or equal to 5 m/minute. On the other hand, by setting the processing speed to preferably less than or equal to 30 m/minute, compression bonding is easily performed. The processing speed is more preferably less than or equal to 20 m/minute.

Although the combination of the processing temperature (the surface temperature of the roll) and the processing time in permanent compression bonding is not particularly limited, it is preferable to increase the processing time when decreasing the processing temperature, and to decrease the processing time when increasing the processing temperature, in order to obtain a long-fiber nonwoven fabric including fibers having a suitable degree of crystallization.

Specifically, when the processing temperature is more than or equal to 120° C. and less than 140° C., the processing time is preferably more than or equal to 20 seconds and less than or equal to 35 seconds; when the processing temperature is more than or equal to 140° C. and less than 160° C., the processing time is preferably more than or equal to 10 seconds and less than or equal to 25 seconds; and when the processing temperature is more than or equal to 160° C. and less than or equal to 190° C., the processing time is preferably more than or equal to 3 seconds and less than or equal to 15 seconds.

The long-fiber nonwoven fabric of the present invention obtained as described above is suitable for a filter reinforcement material, which is excellent in pleating property and pleat shape retention property.

### EXAMPLES

In the following, the present invention will be described more specifically based on examples. It should be noted that the present invention is not limited by the following examples, and can also be implemented by making modifications within a range in which they can be consistent with purports described above and hereinafter. Any of such modifications are encompassed in the technical scope of the present invention.

### Intrinsic Viscosity

First, 0.1 g of a polyethylene terephthalate resin was weighed and dissolved in 25 ml of a mixed solvent of phenol and tetrachloroethane (60/40 (mass ratio)). Intrinsic viscosity was measured three times at 30° C. using an Ostwald viscometer, and an average value thereof was determined.

### Glass Transition Point Temperature

According to JIS K7122 (1987), the glass transition point temperature of a thermoplastic polystyrene-based copolymer was determined at a temperature increasing rate of 20° C./minute, using Q100 manufactured by TA Instruments, Inc.

### Basis Weight Amount

According to JIS L1913 (2010) 6.2, a basis weight amount, which is a mass per unit area, was measured.

### Average Fiber Diameter

Five arbitrary positions in a sample of a long-fiber nonwoven fabric were selected, the diameter of each single fiber was measured for n=20 using an optical microscope, and an average value thereof was determined.

### Birefringence Index (Δn)

Five arbitrary positions in the sample of the long-fiber nonwoven fabric were selected and single fibers were taken out therefrom, fiber diameters and retardation were read using a NIKON polarizing microscope OPTIPHOT-POL, and a birefringence index (Δn) was determined.

### Bending Resistance

According to JIS L1096 (2010) 8.22.1 Method A (Gurley method), the sample had a width of 25 mm and a length of 89 mm, and five arbitrary positions were selected in each of an MD direction and a CD direction in the long-fiber nonwoven fabric. In each of the MD direction and the CD direction, bending resistances were measured with a load of 5 g, and an average value of all values in each direction was defined as a measured value.

### Degree of Crystallization

Ten arbitrary positions in the sample of the long-fiber nonwoven fabric were selected, specific gravities were measured using a density gradient tube, and a degree of crystallization was determined by the following equation:

degree of crystallization=(the specific gravity of the sample−the specific gravity of an amorphous region)/(the specific gravity of a crystalline region−the specific gravity of the amorphous region)×100.

It should be noted that, in the case of a polyethylene terephthalate long-fiber nonwoven fabric, the specific gravity of an amorphous region is 1.335, and the specific gravity of a crystalline region is 1.515.

### Aspect Ratio

Ten arbitrary positions in the sample of the long-fiber nonwoven fabric were selected, and a longer radius and a shorter radius of each fiber cross section were measured using a SEM. Then, an aspect ratio therebetween was determined by the following equation, and an average value thereof was defined as a measured value.

aspect ratio=longer radius/shorter radius

### Folding Angle

A test piece having a width of 50 mm and a length of 60 mm was folded in two in a length direction, pressed for 10 seconds under a pressure of 5.2 kPa at 80° C., and an open angle of the folded test piece obtained 60 seconds after unloading was determined as a folding angle.

### Evaluation of Close Contact between Pleats

In the long-fiber nonwoven fabric having a size of 150 cm by 150 cm, a unit of 25 pleats was fabricated with a pleat height being set to 30 mm. Then, air was blown through the long-fiber nonwoven fabric at a planar wind speed of more than or equal to 1 m/minute and less than or equal to 4 m/minute, and it was visually checked in which wind speed range the pleats were brought into close contact with each other.

As a measurement sample, a composite of the long-fiber nonwoven fabric and a PP melt blown nonwoven fabric with a fiber diameter of substantially 1 μm (basis weight amount: 20 g/m²) using a low melting-point adhesive nonwoven fabric (DYNAC manufactured by Kureha Tech) was used.

A: pleats were brought into close contact with each other at a planar wind speed of more than or equal to 3 m/minute

B: pleats were brought into close contact with each other at a planar wind speed of more than or equal to 2 m/minute and less than 3 m/minute

C: pleats were brought into close contact with each other at a planar wind speed of more than or equal to 1 m/minute and less than 2 m/minute

### Example 1

A resin containing polyethylene terephthalate having an intrinsic viscosity of 0.63 and 0.40 mass % of PLEXIGLAS HW55 manufactured by Rohm GmbH & Co. KG (hereinafter referred to as “HW55”), which is a styrene-methyl methacrylate-maleic anhydride copolymer having a glass transition point temperature of 122° C., mixed thereto was spun from a spinneret having an orifice diameter of 0.45 mm at a single hole discharge amount of 3.5 g/minute, using a long-fiber nonwoven fabric spinning apparatus. Further, dry air was supplied to an ejector at a pressure (jet pressure) of 110 kPa, and the resin was drawn in one step. Fibers of the resin were opened onto a conveyor located below and were collected. Thereby, a long-fiber fleece was obtained. The spinning speed calculated from the fiber diameter was 2121 m/minute.

The obtained long-fiber fleece was subjected to temporary compression bonding, using a pair of temporary thermocompression bonding rolls including two flat rolls, at a surface temperature of each flat roll of 80° C. and a pushing pressure of 8 kN/m. Then, the long-fiber fleece was subjected to permanent compression bonding under planar constraint using a felt calender, at a surface temperature of a roll (processing temperature) of 180° C., under conditions of a pushing pressure of 300 kPa, a processing time of 4 seconds, and a processing speed of 20 m/minute. Thereby, a long-fiber nonwoven fabric was obtained.

The obtained long-fiber nonwoven fabric had a basis weight amount of 90 g/m², an average fiber diameter of 39 μm, a birefringence index of 0.0098, a degree of crystallization of 13.5%, a bending resistance of 157 mg, and a folding angle of 0°.

Table 1 lists spinning conditions and measurement results.

### Example 2

A long-fiber fleece was obtained under the same conditions as those in Example 1, except that dry air was supplied to the ejector at a pressure (jet pressure) of 75 kPa. The spinning speed calculated from the fiber diameter was 1777 m/minute.

The obtained long-fiber fleece was subjected to temporary compression bonding as in Example 1, and then was subjected to permanent compression bonding under planar constraint using the felt calender, at a surface temperature of the roll (processing temperature) of 145° C., under conditions of a pushing pressure of 300 kPa, a processing time of 24 seconds, and a processing speed of 3.0 m/minute. Thereby, a long-fiber nonwoven fabric was obtained.

The obtained long-fiber nonwoven fabric had a basis weight amount of 93 g/m², an average fiber diameter of 43 μm, a birefringence index of 0.0050, a degree of crystallization of 20.1%, a bending resistance of 132 mg, and a folding angle of 5°.

Table 1 lists spinning conditions and measurement results.

### Example 3

A long-fiber fleece was obtained under the same conditions as those in Example 1, except that the resin was spun from the spinneret at a single hole discharge amount of 5.0 g/minute, and dry air was supplied to the ejector at a pressure (jet pressure) of 200 kPa. The spinning speed calculated from the fiber diameter was 3119 m/minute.

The obtained long-fiber fleece was subjected to temporary compression bonding and permanent compression bonding as in Example 2. Thereby, a long-fiber nonwoven fabric was obtained.

The obtained long-fiber nonwoven fabric had a basis weight amount of 90 g/m², an average fiber diameter of 39 μm, a birefringence index of 0.0166, a bending resistance of 162 mg, a degree of crystallization of 22.8%, and a folding angle of 12°.

Table 1 lists spinning conditions and measurement results.

### Example 4

A long-fiber fleece was obtained under the same conditions as those in Example 1, except that the resin was spun from the spinneret at a single hole discharge amount of 4.2 g/minute, and dry air was supplied to the ejector at a pressure (jet pressure) of 150 kPa. The spinning speed calculated from the fiber diameter was 2609 m/minute.

The obtained long-fiber fleece was subjected to temporary compression bonding and permanent compression bonding as in Example 2. Thereby, a long-fiber nonwoven fabric was obtained.

The obtained long-fiber nonwoven fabric had a basis weight amount of 71 g/m², an average fiber diameter of 39 μm, a birefringence index of 0.0091, a bending resistance of 133 mg, a degree of crystallization of 20.9%, and a folding angle of 8°.

Table 1 lists spinning conditions and measurement results.

### Example 5

A long-fiber fleece was obtained under the same conditions as those in Example 1, except that dry air was supplied to the ejector at a pressure (jet pressure) of 210 kPa. The spinning speed calculated from the fiber diameter was 3587 m/minute.

The obtained long-fiber fleece was subjected to temporary compression bonding and permanent compression bonding as in Example 2. Thereby, a long-fiber nonwoven fabric was obtained.

The obtained long-fiber nonwoven fabric had a basis weight amount of 70 g/m², an average fiber diameter of 33 μm, a birefringence index of 0.0190, a bending resistance of 109 mg, a degree of crystallization of 23.7%, and a folding angle of 13°.

Table 1 lists spinning conditions and measurement results.

### Example 6

A long-fiber fleece was obtained under the same conditions as those in Example 1, except that the resin was spun from the spinneret at a single hole discharge amount of 3.5 g/minute, and dry air was supplied to the ejector at a pressure (jet pressure) of 75 kPa. The spinning speed calculated from the fiber diameter was 1777 m/minute.

The obtained long-fiber fleece was subjected to temporary compression bonding and permanent compression bonding as in Example 2. Thereby, a long-fiber nonwoven fabric was obtained.

The obtained long-fiber nonwoven fabric had a basis weight amount of 71 g/m², an average fiber diameter of 43 μm, a birefringence index of 0.0050, a bending resistance of 111 mg, a degree of crystallization of 19.7%, and a folding angle of 5°.

Table 1 lists spinning conditions and measurement results.

### Comparative Example 1

A long-fiber fleece was obtained as in Example 1. The spinning speed calculated from the fiber diameter was 2121 m/minute.

The obtained long-fiber fleece was subjected to temporary compression bonding as in Example 1, and then was subjected to permanent compression bonding under planar constraint using the felt calender, at a surface temperature of the roll (processing temperature) of 165° C., under conditions of a pushing pressure of 300 kPa, a processing time of 24 seconds, and a processing speed of 3.0 m/minute. Thereby, a long-fiber nonwoven fabric was obtained.

The obtained long-fiber nonwoven fabric had a basis weight amount of 90 g/m², an average fiber diameter of 39 μm, a birefringence index of 0.0098, a bending resistance of 133 mg, a degree of crystallization of 26%, and a folding angle of 17°.

Table 1 lists spinning conditions and measurement results.

### Comparative Example 2

A long-fiber fleece was obtained under the same conditions as those in Example 1, except that the resin was spun from the spinneret at a single hole discharge amount of 4.2 g/minute, and dry air was supplied to the ejector at a pressure (jet pressure) of 185 kPa. The spinning speed calculated from the fiber diameter was 3139 m/minute.

The obtained long-fiber fleece was subjected to temporary compression bonding and permanent compression bonding as in Example 2. Thereby, a long-fiber nonwoven fabric was obtained.

The obtained long-fiber nonwoven fabric had a basis weight amount of 91 g/m², an average fiber diameter of 35 μm, a birefringence index of 0.0220, a bending resistance of 255 mg, a degree of crystallization of 28.7%, and a folding angle of 20°.

Table 1 lists spinning conditions and measurement results.

### Comparative Example 3

A long-fiber fleece was obtained under the same conditions as those in Example 1, except that the resin was spun from the spinneret at a single hole discharge amount of 1.6 g/minute, and dry air was supplied to the ejector at a pressure (jet pressure) of 75 kPa. The spinning speed calculated from the fiber diameter was 1856 m/minute.

The obtained long-fiber fleece was subjected to temporary compression bonding and permanent compression bonding as in Example 1. Thereby, a long-fiber nonwoven fabric was obtained.

The obtained long-fiber nonwoven fabric had a basis weight amount of 70 g/m², an average fiber diameter of 28 μm, a birefringence index of 0.0199, a bending resistance of 64 mg, a degree of crystallization of 25.5%, and a folding angle of 16°.

Table 1 lists spinning conditions and measurement results.

TABLE 1

| | | | | | | | | | Compar- | Compar- | Compar- |
|---|---|---|---|---|---|---|---|---|---|---|---|
| | | | Example | Example | Example | Example | Example | Example | ative | ative | ative |
| | | | 1 | 2 | 3 | 4 | 5 | 6 | Example 1 | Example 2 | Example 3 |
| Spinning | Spinneret | [° C.] | 285 | 285 | 285 | 285 | 285 | 285 | 285 | 285 | 285 |
| Conditions | temperature | | | | | | | | | | |
| | Single hole | [g/min] | 3.5 | 3.5 | 5.0 | 4.2 | 4.2 | 3.5 | 3.5 | 4.2 | 1.6 |
| | discharge amount | | | | | | | | | | |
| | Jet pressure | [kPa] | 110 | 75 | 200 | 150 | 210 | 75 | 110 | 185 | 75 |
| | Draft ratio | | 115 | 79 | 119 | 119 | 163 | 97 | 115 | 143 | 229 |
| Physical | Basis weight | [g/m²] | 90 | 93 | 90 | 71 | 70 | 71 | 90 | 91 | 70 |
| Properties | amount | | | | | | | | | | |
| of Non- | Average fiber | [μm] | 39 | 43 | 35 | 39 | 33 | 43 | 39 | 35 | 28 |
| woven | diameter | | | | | | | | | | |
| Fabric | Birefringence | ×10⁻³ | 9.8 | 5.0 | 16.6 | 9.1 | 19.0 | 5.0 | 9.8 | 22.0 | 19.9 |
| | index (Δn) | | | | | | | | | | |
| | Bending | [mg] | 157 | 132 | 162 | 133 | 109 | 111 | 133 | 255 | 64 |
| | resistance | | | | | | | | | | |
| | Degree of | [%] | 13.5 | 19.5 | 22.8 | 20.9 | 23.7 | 19.0 | 26.0 | 28.7 | 25.5 |
| | crystallization | | | | | | | | | | |
| Pleating | Folding angle | [°] | 0 | 5 | 12 | 8 | 13 | 5 | 17 | 20 | 16 |
| Property | Close contact | | A | B | A | A | B | B | B | A | C |
| | between pleats | | | | | | | | | | |

As shown in Table 1, the long-fiber nonwoven fabrics in Examples 1 to 6 satisfying the requirements defined in the present invention were excellent in pleating property and pleat shape retention property.

In the long-fiber nonwoven fabric obtained in Comparative Example 1, fibers constituting the long-fiber nonwoven fabric had a degree of crystallization of more than 25%. Thus, the long-fiber nonwoven fabric had a poor pleating property.

Although the long-fiber nonwoven fabric obtained in Comparative Example 2 had an excellent pleating property, fibers constituting the long-fiber nonwoven fabric had a degree of crystallization of more than 25%. Thus, the long-fiber nonwoven fabric had a poor pleating property.

In the long-fiber nonwoven fabric obtained in Comparative Example 3, fibers constituting the long-fiber nonwoven fabric had a degree of crystallization of more than 25%. Thus, the long-fiber nonwoven fabric had a poor pleating property. In addition, the long-fiber nonwoven fabric had a poor pleat shape retention property, which easily caused close contact between pleats.

### INDUSTRIAL APPLICABILITY

The long-fiber nonwoven fabric obtained in the present invention is a long-fiber nonwoven fabric suitable for a filter reinforcement material, which is excellent in pleating property, has rigidity that is less likely to cause close contact between pleats under actual use, and is excellent in pleat shape retention property. In addition, since the long-fiber nonwoven fabric is made of fibers having a single component, a long-fiber nonwoven fabric that is manufactured at an inexpensive cost can be provided, making a significant contribution to the industrial world.

1. A long-fiber nonwoven fabric comprising fibers having a birefringence index (Δn) of more than or equal to 0.005 and less than or equal to 0.020, a degree of crystallization of less than or equal to 25%, and an average fiber diameter of more than or equal to 30 and less than or equal to 60 the long-fiber nonwoven fabric having a basis weight amount of more than or equal to 50 g/m² and less than or equal to 120 g/m², and a folding angle after being pressed for 10 seconds under a pressure of 5.2 kPa at 80° C. of less than or equal to 15°.

2. The long-fiber nonwoven fabric according to claim 1, wherein an average value of aspect ratios of fiber cross sections of the fibers constituting the long-fiber nonwoven fabric is more than or equal to 1.05 and less than or equal to 1.2.

3. The long-fiber nonwoven fabric according to claim 1[[ or 2]], wherein the fibers constituting the long-fiber nonwoven fabric are single fibers made of a resin containing polyethylene terephthalate serving as a main component and more than or equal to 0.02 mass % and less than or equal to 5 mass % of a thermoplastic polystyrene-based copolymer mixed thereto.

4. The long-fiber nonwoven fabric according to claim 3, wherein the thermoplastic polystyrene-based copolymer has a glass transition point temperature of more than or equal to 100° C. and less than or equal to 160° C.

5. A filter reinforcement material using the long-fiber nonwoven fabric according to claim 1.
